(19) United States
(12) Patent Application Publication
(10) Pub. No.: US 2026/0353017 A1
(43) Pub. Date: Nov. 5, 2026

(54) Method And Apparatus For Automatically Configuring Microphone Directionality On Basis Of Estimating Location Of User Or Object By Using Hearing Aid

(71) Applicant: Olive Union, Inc., Seoul (KR)

(72) Inventors: Myung Geun SONG, Seoul (KR); Taeho SON, Seoul (KR); Yoonsoo KIM, Seoul (KR); Donghyun LEE, Seoul (KR)

(73) Assignee: Olive Union, Inc., Seoul (KR)

(21) Appl. No.: 19/100,033

(22) PCT Filed: Oct. 21, 2022
(86) PCT No.: PCT/KR2022/016148

§ 371 Date: Jan. 30, 2025

(30) Foreign Application Priority Data
Sep. 16, 2022 (KR) 10-2022-0116900

(51) Int. Cl. H04R 25/00

(52) U.S. Cl. CPC H04R 25/405; H04R 25/554

(57) ABSTRACT

Disclosed arc a method and an apparatus for automatically configuring microphone directionality on the basis of estimating the location of a user or an object by using a hearing aid. A method for automatically configuring microphone directionality on the basis of estimating the location of a user or an object by using a hearing aid according to an embodiment may comprise the steps of: estimating, through a sensor unit of a hearing aid worn by a user, the direction or location of the user or estimating the direction or location of an object communicating with the user; and automatically changing beamforming for microphone directionality on the basis of the location of the user or the object.

### TECHNICAL FIELD

The following embodiments relate to a method and an apparatus for automatically configuring microphone directionality on the basis of estimating a location of a user or an object by using a hearing aid, and more particularly, to a method and an apparatus for automatically configuring microphone directionality on the basis of estimating a location of a user or an object by using a hearing aid that automatically configures microphone directionality on the basis of a location of a user or a location or number of objects.

### BACKGROUND ART

In recent years, the rapid development of medical engineering technology has made it possible for patients who have not received much help by wearing hearing aids in the past to select and wear suitable hearing aids, thereby achieving excellent hearing improvement. Hearing aids are advanced medical devices that are always attached to the body among medical devices, and must be constantly managed according to changes in hearing, and must receive A/S for parts damaged by moisture and foreign substances in the ear. Existing hearing aids have been in the form of trumpet-type sound collectors, but are now commonly used in the form of electric hearing aids to help amplify sound. In addition, the hearing aid has a bone conduction type structure in which the hearing aid is mounted on a mastoid portion, but is usually of an air conduction type structure, and receives a sound wave with a microphone, converts the sound wave into an electric vibration, enlarges the electric vibration, converts the electric vibration into a sound wave again with an earphone, and makes the sound wave audible to the ear.

The “directivity” of the microphone of the hearing aid may allow users using the hearing aid to hear better. Hearing aids generally use sparse two microphones with omnidirectional characteristics to calculate the microphone directional signal. However, in this case, the directivity that has been set once cannot be actively dealt with depending on the situation. In addition, a cumbersome procedure has to be taken in the case of changing the directivity and setting the correction.

FIG. 1 is a diagram for explaining directional setting of a general hearing aid.

As shown in FIG. 1, a general hearing aid may measure a direction in which a sound is heard around a user, and the user needs to change the direction according to the direction in which the sound is heard. That is, the directional index is fixed according to the direction of the user wearing the hearing aid.

FIG. 2 is a diagram for explaining a directional change of a general hearing aid.

As shown in FIG. 2(a), in the case of a general hearing aid, the direction of the microphone may be changed in the direction in which the sound source (e.g., speech) is heard, but the direction of the sound source is actually continuously changed, and it is very cumbersome to change it every time. In order to change the directivity of the microphone of the hearing aid, the directivity may be changed after connecting a terminal or the like to the hearing aid. For example, the directivity of the hearing aid may be changed after connecting a PC and the hearing aid, or the directivity of the hearing aid may be changed after connecting a smartphone and the hearing aid. It is also possible to change the directivity of the hearing aid after connecting a remote controller and the hearing aid. An omni-direction state may be provided through beamforming axis rotation as shown in FIG. 2(b).

Korean Patent No. 10-2004460 relates to a digital hearing device using such a Bluetooth circuit and digital signal processing, and describes a technology related to the digital hearing device that may provide an optimized hearing aid function suitable for a user hearing profile and a hearing aid wearing environment in a limited resource of a Bluetooth module by using the Bluetooth circuit and the digital signal processing.

### DETAILED DESCRIPTION OF THE INVENTION

### Technical Problem

Embodiments describe a method and an apparatus for automatically configuring microphone directionality on the basis of estimating the location of a user or an object by using a hearing aid, and more particularly, provide a technique for increasing the performance of a hearing aid by automatically configuring a microphone directionality (beamforming) suitable for the situation and environment according to the location of the user or the location or number of objects.

Embodiments are directed to providing a method and an apparatus for automatically configuring microphone directionality on the basis of estimating the location of a user or an object by using a hearing aid, by estimating, through a sensor unit of a hearing aid, the direction or location of the user or estimating the direction or location of an object communicating with the user, thereby automatically changing beamforming for microphone directionality on the basis of the direction or location of the user or the object, thereby making the hearing aid more audible and improving the performance of the hearing aid.

### Technical Solution

A method for automatically configuring microphone directionality on the basis of estimating the location of a user or an object by using a hearing aid according to an embodiment may include: a step of estimating, through a sensor unit of a hearing aid worn by a user, the direction or location of the user or estimating the direction or location of an object communicating with the user; and a step of automatically changing beamforming for microphone directionality on the basis of the location of the user and the object.

The method may further include a step of detecting the user or the object according to the estimated direction or location and mapping the location, and automatically changing beamforming for microphone directionality on the basis of the mapped location of the user and the object.

The sensor unit may be at least any one or more of an acceleration sensor, a proximity sensor, a lidar sensor, a heat-detecting sensor, a movement sensor, an infrared emitter, and a light sensor.

The step of estimating the direction or location, may include configuring a beamforming setting value according to a location and direction of the user by recognizing a movement direction of the user through a the sensor unit of the hearing aid.

The step of estimating the direction or location, may include configuring a beamforming setting value according to the direction or location of the object by estimating, through the sensor unit of the hearing aid, the direction or location of the object when the distance between the user and the object is within a predetermined distance.

The step of estimating the direction or location, may include configuring a beamforming setting value according to the direction or location in which sound is generated by recognizing the direction or location in which the sound is generated.

The step of estimating the direction or location may include identifying the number of the objects within a predetermined distance from the user, and estimating a direction or location of each of the objects, and the step of automatically changing beamforming may include changing to a multi-beamforming setting according to the number of objects.

The step of estimating the direction or location may include recognizing the object through infrared light emitted by using an infrared emitter; recognizing the object through reflected light by using a light sensor; and then recognizing that the object exists in an overlapping portion between a portion recognized by the infrared emitter and a portion recognized by the light sensor.

An apparatus for automatically configuring microphone directionality on the basis of estimating the location of a user or an object by using a hearing aid according to some embodiments may include: a sensor unit configured in a hearing aid worn by a user, wherein the sensor unit estimates the direction or location of the user or estimates the direction or location of an object communicating with the user; and a beamforming configuring unit for automatically changing beamforming for microphone directionality on the basis of a location of the user or the object.

The apparatus may further include a location mapping unit for detecting the user or the object on the basis of the estimated direction or location and mapping the location, and automatically changing beamforming for microphone directionality on the basis of the mapped location of the user or the object.

The sensor unit may be at least any one or more of an acceleration sensor, a proximity sensor, a lidar sensor, a heat-detecting sensor, a movement sensor, an infrared emitter, and a light sensor.

When the sensor unit recognizes a movement direction of the user, the beamforming configuring unit may configure a beamforming setting value according to a location and a direction of the user.

When the sensor unit estimates a direction or location of the object when a distance between the user and the object is within a predetermined distance, the beamforming configuring unit may configure a beamforming setting value according to the direction or location of the object.

When the sensor unit recognizes a direction or location in which sound is generated, the beamforming configuring unit may configure a beamforming setting value according to the direction or location in which the sound is generated.

The sensor unit may identify the number of the objects within a predetermined distance from the user, and estimate a direction or location of each of the objects, and the beamforming configuring unit may change to a multi-beamforming setting according to the number of objects.

The sensor unit may recognize the object through infrared light emitted by using an infrared emitter, and recognizes the object through reflected light by using a light sensor, and then recognizes that the object exists in an overlapping portion between a portion recognized by the infrared emitter and a portion recognized by the light sensor.

### Advantageous Effects

According to embodiments, a method and an apparatus for automatically configuring microphone directionality on the basis of estimating the location of a user or an object by using a hearing aid, by estimating, through a sensor unit of a hearing aid, the direction or location of the user or estimating the direction or location of an object communicating with the user, thereby automatically changing beamforming for microphone directionality on the basis of the direction or location of the user or the object, thereby making the hearing aid more audible and improving the performance of the hearing aid.

### BRIEF DESCRIPTION OF THE DRAWINGS

FIG. 1 is a diagram for explaining directional setting of a general hearing aid.

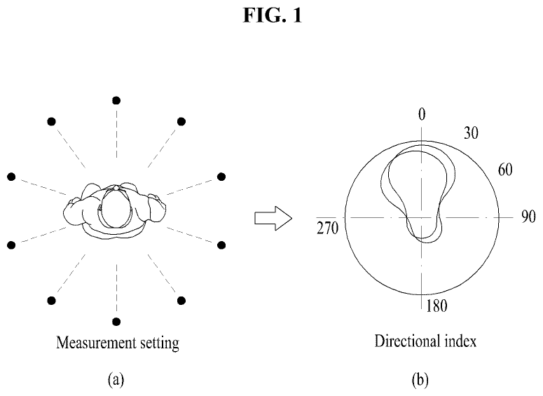

FIG. 2 is a diagram for explaining a directional change of a general hearing aid.

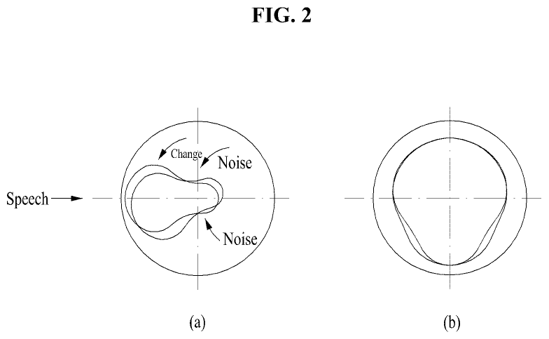

FIG. 3 is a diagram illustrating an example of a hearing aid according to an embodiment.

FIG. 4 is a diagram for describing a method for automatically configuring microphone directionality on the basis of estimating the location of a user by using a hearing aid, according to an embodiment.

FIG. 5 is a diagram for describing a method for automatically configuring microphone directionality on the basis of estimating the location of an object by using a hearing aid, according to an embodiment.

FIG. 6 is a diagram for describing a method for automatically configuring microphone directionality on the basis of a sound direction by recognizing a sound of an object by using a hearing aid, according to an embodiment.

FIG. 7 is a flowchart illustrating an algorithm for automatically configuring microphone directionality on the basis of estimating the location of a user or an object by using a hearing aid, according to an embodiment.

FIG. 8 is a flowchart illustrating a method for automatically configuring microphone directionality on the basis of estimating the location of a user or an object by using a hearing aid, according to an embodiment.

FIG. 9 is a block diagram illustrating an apparatus for automatically configuring microphone directionality on the basis of estimating the location of a user or an object by using a hearing aid, according to an embodiment.

FIG. 10 is a diagram for describing location estimation of an object by using a sensor according to an embodiment.

FIG. 11 is a diagram for describing person detection and mapping according to an embodiment.

FIG. 12 is a diagram for describing a beamforming change according to an embodiment.

FIG. 13 is a diagram for describing location estimation of multiple objects by using a sensor according to an embodiment.

FIG. 14 is a diagram for describing multi-person detection and mapping according to an embodiment.

FIG. 15 is a diagram for describing multi-beamforming according to an embodiment.

FIG. 16 is a diagram for describing object recognition according to an embodiment.

### MOST PREFERRED EMBODIMENT OF THE INVENTION

Embodiments will now be described with reference to the accompanying drawings. However, the described embodiments may be modified in many different forms, and the scope of the present disclosure is not limited by the embodiments described below. Furthermore, various embodiments are provided to more fully describe the present disclosure to one of ordinary skill in the art. Shapes, sizes, and the like of components in the drawings may be exaggerated for clearer description.

In existing hearing aids, the directivity of a microphone which is set once is not actively changed according to the situation. In addition, in the case of existing hearing aids, even if the directivity of the microphone is changed, an inconvenient system procedure needs to be performed every time the directivity is changed, and it is difficult for the user to directly cope with the procedure.

However, in the embodiments, a sensor may be mounted on a hearing aid to locate the user or the object to be communicated with (e.g., the other party), and the setting value may be automatically converted according to the identified location of the user and the location of the object to be communicated with, so that the user may hear better according to each situation.

The following embodiments relate to a method and an apparatus for automatically configuring microphone directionality on the basis of estimating the location of a user or an object by using a hearing aid, and by automatically configuring a microphone directionality (beamforming) suitable for the situation and environment according to the location of the user or according to the location or the number of the object, sound can may be heard more efficiently than the performance of an existing hearing aid. Embodiments may further take into account the user's hearing status, ambient noise, user-set modes, etc., as well as the object's location estimation.

An apparatus for automatically configuring microphone directionality on the basis of estimating the location of a user or an object by using a hearing aid according to an embodiment may amplify sound in a desired direction as a hearing aid that helps to sense sound for hearing-impaired people with hearing loss. In addition, an apparatus for automatically configuring microphone directionality on the basis of estimating the location of a user or an object by using a hearing aid according to an embodiment may compensate for hearing, amplify sound energy by converting it into a digital signal through electrical amplification, and convert the amplified energy into sound energy according to a desired direction to assist hearing of hearing-impaired people.

Accordingly, the apparatus for automatically configuring microphone directionality on the basis of estimating the location of a user or an object by using a hearing aid according to an embodiment may analyze the sound by an algorithm according to the movement of the user or according to the location of the object to be communicated with, and automatically provide an optimal setting value to suit the situation.

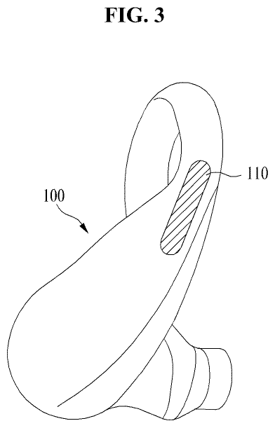

FIG. 3 is a diagram illustrating an example of a hearing aid according to an embodiment.

As shown in FIG. 3, a hearing aid 100 according to an embodiment is configured to be worn on an ear of a user, and may include a microphone, a speaker, and a sensor unit 110. Further, the hearing aid 100 according to the embodiment may further include a wireless communication unit, a control unit, and a power supply unit.

The main body of the hearing aid 100 is attached or worn on the ear of the user, and may include a wireless communication unit, a control unit, a power supply unit, and the like therein.

At least one microphone is configured in the main body, and may receive sound such as voice. The microphone may process an external acoustic signal into electrical voice data. At this time, the microphone may be disposed to be separated from the speaker by a predetermined distance or more, and may be configured to be less restricted by howling and easy to amplify. For example, the microphone may be configured as two microphones, and may be configured as one microphone or three or more microphones according to an embodiment.

The speaker may be configured in the main body to amplify the sound received from the microphone and transmit the amplified sound to the user.

The sensor unit 110 is configured in the main body, and may automatically configure the microphone directionality by estimating a location or direction of a user wearing the hearing aid 100 or by estimating a location or direction of an object communicating with the user. At this time, configuring the microphone directionality may be performed through the control unit.

For example, the sensor unit 110 may be configured as a proximity sensor or a lidar sensor, and a setting value of the microphone may be changed through the control unit by detecting the location of a person communicating with the user through the proximity sensor or the lidar sensor. Here, the sensor unit 110 may include not only a proximity sensor or a lidar sensor, but also various sensors such as a heat-detecting sensor and a movement sensor capable of estimating a direction or location of a user or a direction or location an object.

The hearing aid 100 according to the embodiment may further include a wireless communication unit, a control unit, and a power supply unit.

The wireless communication unit is configured to be embedded in the main body, and is connected to the user terminal through wireless communication. That is, the wireless communication unit may be configured to transmit and receive a wireless signal from a user terminal in a communication network according to wireless Internet technologies.

Examples of the wireless Internet technology include Wireless LAN (WLAN), Wireless-Fidelity (Wi-Fi), Wireless Fidelity (Wi-Fi) Direct, Digital Living Network Alliance (DLNA), Wireless Broadband (WiBro), World Interoperability for Microwave Access (WiMAX), High Speed Downlink Packet Access (HSDPA), High Speed Uplink Packet access (HSUPA), Long Term Evolution (LTE), and Long Term Evolution-Advanced (LTE-A), and the wireless communication unit may transmit and receive data according to at least one wireless Internet technology in a range including Internet technologies not listed above.

Meanwhile, the wireless communication unit may perform short range communication. As the short-range communication technology, at least one of Bluetooth, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technology may be used. However, the present disclosure is not limited thereto, and the wireless communication unit may receive data from the mobile terminal through a short-range communication technology not listed above.

In this way, the wireless communication unit may configure or change the setting of the hearing aid 100 or the like by using the user terminal by being connected to the user terminal through short-range communication.

The control unit is configured to be embedded in the main body and may be implemented to control the overall operation of the components. The control unit may amplify sounds received from a plurality of microphones and transmit the amplified sounds to the user. In particular, the control unit may automatically configure the microphone directionality by estimating the direction or location of the user or by estimating the direction or location of the object. In addition, the control unit may be connected to the user terminal through the wireless communication unit to change setting of the hearing aid 100, such as an amplification gain of an input sound.

For example, after the user installs an application on the user terminal, the user may execute the application to configure an amplification gain for the microphone, and the control unit may receive the control signal to configure the amplification gain for the microphone.

The power supply unit receives an external power supply and an internal power supply under the control of the control unit, and supplies power necessary for the operation of respective components. The power supply includes a battery, and the battery may be a built-in battery configured to be rechargeable. However, the present disclosure is not limited thereto.

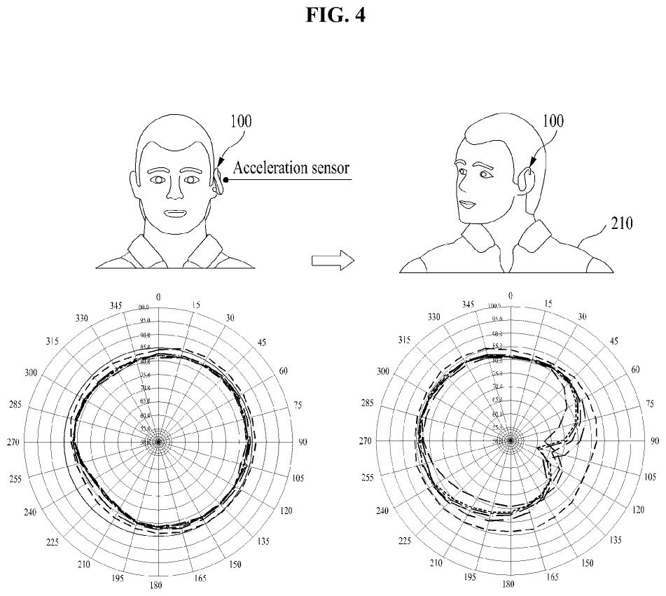

FIG. 4 is a diagram for describing a method for automatically configuring microphone directionality on the basis of estimating the location of a user by using a hearing aid, according to an embodiment.

Referring to FIG. 4, microphone directionality may be automatically configured according to the location of a user 210 wearing the hearing aid 100 by using the sensor unit 110 configured in the hearing aid 100. This may be performed by an apparatus that automatically configures the microphone directionality on the basis of estimating the location of the user 210 by using the hearing aid 100 according to an embodiment. The apparatus for automatically configuring the microphone directionality on the basis of estimating the location of the user 210 by using the hearing aid 100 according to an embodiment may be simply referred to as an apparatus for automatically configuring microphone directionality.

For example, the apparatus for automatically configuring microphone directionality may change the microphone directionality (beamforming) according to the movement direction of the user 210 wearing the hearing aid 100 through the acceleration sensor of the hearing aid 100 to set the setting value according to the location and angle of the user 210. Thereafter, when the user 210 rotates in the lateral direction, the apparatus for automatically configuring microphone directionality may automatically convert the microphone directionality (beamforming) corresponding to the direction in which the sensor unit 110 recognizes and moves. At this time, the user 210 may rotate his/her entire body or rotate the direction of his/her face.

Here, when a microphone value is configured based on 0 degree, the apparatus for automatically configuring microphone directionality may analyze the directivity of the angle moved through an algorithm, automatically convert a value corresponding thereto, and apply an optimal value suitable for the user environment.

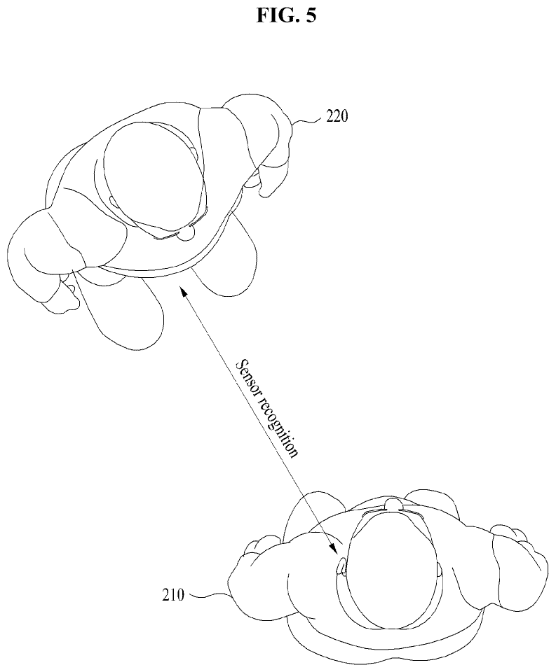

FIG. 5 is a diagram for describing a method for automatically configuring microphone directionality on the basis of estimating the location of an object by using a hearing aid, according to an embodiment.

Referring to FIG. 5, microphone directionality may be automatically configured on the basis of estimating the location of an object 220 by using the hearing aid according to an embodiment, but a setting value of the microphone may be changed by locating the person communicating with the user 210 through a proximity sensor or a lidar sensor.

For example, the apparatus for automatically configuring microphone directionality may configure a beamforming value according to a direction when the object 220 approaches the user 210 through an IR and proximity sensor or a lidar sensor, and may apply optimal efficiency according to the direction.

At this time, the apparatus for automatically configuring microphone directionality may recognize the number of people around the user 210 through a sensor mounted on the hearing aid. That is, the sensor of the hearing aid may recognize whether the object (220) is one person or multiple persons.

The apparatus for automatically configuring microphone directionality may automatically convert the microphone directionality (beamforming) according to the direction of the object 220 to be communicated with by applying a system algorithm according to the recognized environment.

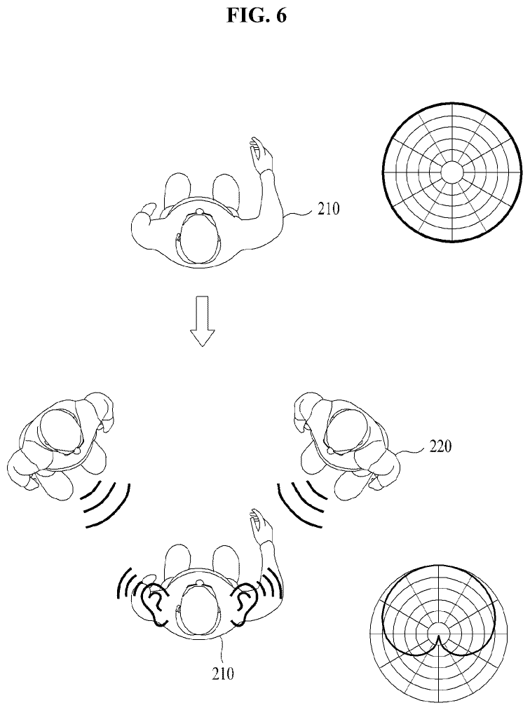

FIG. 6 is a diagram for describing a method of automatically configuring microphone directionality on the basis of a sound direction by recognizing a sound of an object by using a hearing aid, according to an embodiment.

Referring to FIG. 6, an optimal setting value may be automatically changed according to the sound direction by identifying the sound of the object 220 communicating in the basic direction by an algorithm.

For example, the apparatus for automatically configuring microphone directionality may apply a circular shape to three or more microphones to distinguish sounds from different directions.

The apparatus for automatically configuring microphone directionality may recognize the direction of sound and the number of people through deep learning, and may configure the microphone directionality (beamforming) corresponding thereto to apply an optimal setting value.

In addition, the apparatus for automatically configuring microphone directionality may analyze sounds of objects and people through an algorithm and automatically change the microphone directionality (beamforming) according to the environment of the user 210.

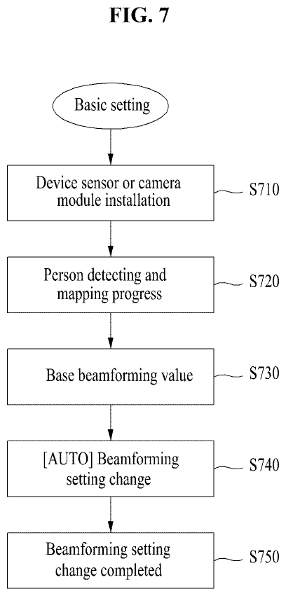

FIG. 7 is a flowchart illustrating an algorithm for automatically configuring microphone directionality on the basis of estimating the location of a user or an object by using a hearing aid, according to an embodiment.

Referring to FIG. 7, algorithm for automatically configuring microphone directionality on the basis of estimating the location of a user 210 or an object 220 by using a hearing aid according to an embodiment may be performed by the apparatus for automatically configuring microphone directionality on the basis of estimating the location of the user 210 or the object 220 by using the hearing aid according to the embodiment.

A sensor or a camera module may be mounted (S710) to detect and map the object 220 (S720). At this time, the location or direction of the object 220 may be detected and mapped. Accordingly, a beamforming setting change may be completed (S750) by automatically changing the beamforming setting value (S740) according to the location or direction mapped from a basic beamforming value (S730).

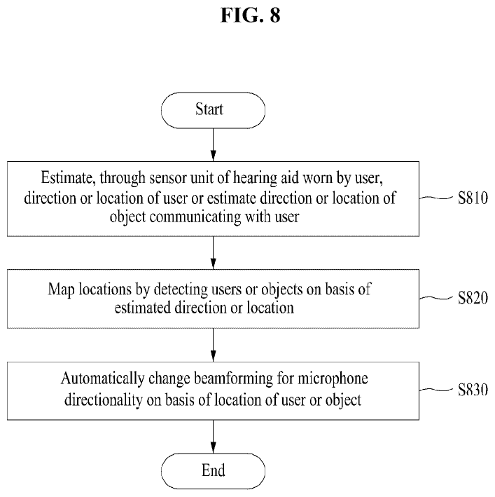

FIG. 8 is a flowchart illustrating a method for automatically configuring microphone directionality on the basis of estimating the location of a user or an object by using a hearing aid, according to an embodiment.

Referring to FIG. 8, a method for automatically configuring microphone directionality on the basis of estimating the location of a user or an object by using a hearing aid according to an embodiment may include a step S810 of estimating, through a sensor unit of a hearing aid worn by a user, the direction or location of the user or the direction or location of an object communicating with the user, and a step S830 of automatically changing beamforming for microphone directionality on the basis of the location of the user or the object.

In addition, the method may further include a step S820 of detecting a the user or an the object according to an the estimated direction or location and mapping the location, and may automatically change beamforming for microphone directionality according to the mapped location of the user or the object.

The method for automatically configuring microphone directionality on the basis of estimating the location of a user or an object by using a hearing aid according to an embodiment will be described in more detail below.

The method for automatically configuring microphone directionality on the basis of estimating the location of a user or an object by using a hearing aid according to an embodiment may be described by taking as an example, an apparatus for automatically configuring microphone directionality on the basis of estimating the location of a user or an object by using a hearing aid according to an embodiment.

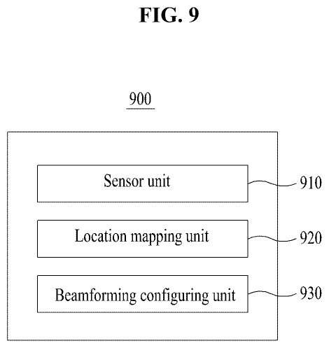

FIG. 9 is a block diagram illustrating an apparatus for automatically configuring microphone directionality on the basis of estimating the location of a user or an object by using a hearing aid, according to an embodiment.

Referring to FIG. 9, the apparatus 900 for automatically configuring microphone directionality on the basis of estimating the location of a user or an object by using a hearing aid according to an embodiment may include a sensor unit 910 and a beamforming configuring unit 930, and may further include a location mapping unit 920 according to an embodiment. The sensor unit 910 may include or be included in the sensor unit 910 described with reference to FIG. 3, and the beamforming configuring unit 930 and the location mapping unit 920 may include or be included in the control unit described with reference to FIG. 3.

In step S810, the sensor unit 910 may estimate, through the sensor unit 910 of the hearing aid worn by a user, the direction or location of the user or the direction or location of an object communicating with the user. Here, the sensor unit 910 may be at least any one or more of an acceleration sensor, a proximity sensor, a lidar sensor, a heat-detecting sensor, a movement sensor, an infrared emitter, and a light sensor.

For example, the sensor unit 910 may include an acceleration sensor and a proximity sensor. The sensor unit 910 may change the microphone directionality (beamforming) according to the movement direction of the user wearing the hearing aid through the acceleration sensor. In addition, the sensor unit 910 may configure a beamforming value according to a direction in which an object approaches a user through an IR and proximity sensor or a lidar sensor.

As another example, the sensor unit 910 may recognize an object through infrared light emitted by using an infrared emitter, recognize an object through light reflected by using a light sensor, and then recognize that an object exists in an overlapping portion between a portion recognized by the infrared emitter and a portion recognized by the light sensor.

In step S820, the location mapping unit 920 may map a location by detecting the user or the object according to the estimated direction or location.

In step S830, the beamforming configuring unit 930 may automatically change beamforming for microphone directionality according to the estimated or mapped location of the user or the object.

As an example, the sensor unit 910 may recognize the movement direction of the user, and thus the beamforming configuring unit 930 may configure the beamforming setting value according to the location and the direction of the user.

As another example, as the sensor unit 910 estimates the direction or location of the object when the distance between the user and the object is within a predetermined distance, the beamforming configuring unit 930 may configure the beamforming setting value according to the direction or location of the object.

As another example, as the sensor unit 910 recognizes the direction or location in which a sound is generated, the beamforming configuring unit 930 may configure the beamforming setting value according to the direction or location in which the sound is generated.

In addition, the sensor unit 910 may identify the number of objects within a predetermined distance from the user, estimate the direction or location of each object, and the beamforming configuring unit 930 may change to a multi-beamforming setting according to the number of objects.

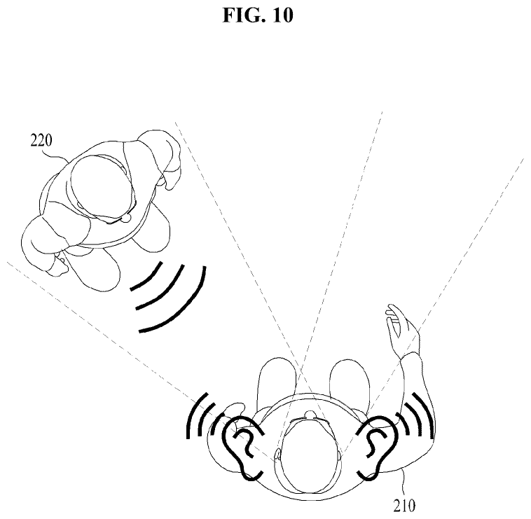

Referring to FIGS. 10 to 12, a method for automatically configuring microphone directionality on the basis of estimating the location of a user 210 or an object 220 using a hearing aid according to an embodiment will be described. Here, a case in which the number of object 220 communicating with the user 210 is one person will be described as an example.

FIG. 10 is a diagram for describing location estimation of an object by using a sensor according to an embodiment. As shown in FIG. 10, the location of the object 220 may be estimated through the sensor unit of the hearing aid worn by the user 210. At this time, a proximity sensor, a heat-detecting sensor, a movement sensor, or the like may be used as the sensor unit.

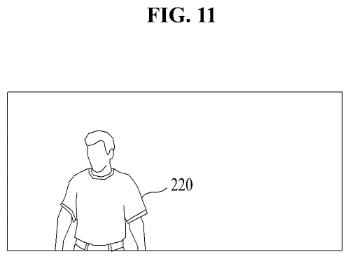

FIG. 11 is a diagram for describing person detection and mapping according to an embodiment. As shown in FIG. 11, the sensor unit of the hearing aid worn by the user 210 may detect the person, that is, the object 220 according to the location estimation of the object 220, and map the location thereof through the location mapping unit.

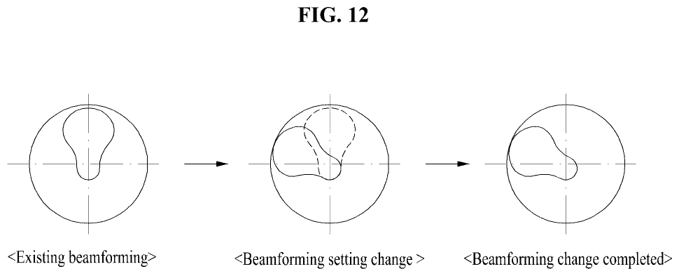

FIG. 12 is a diagram for describing a beamforming change according to an embodiment. Referring to FIG. 12, the beamforming configuring unit may change the beamforming setting according to the location of the mapped person in a basic beamforming state.

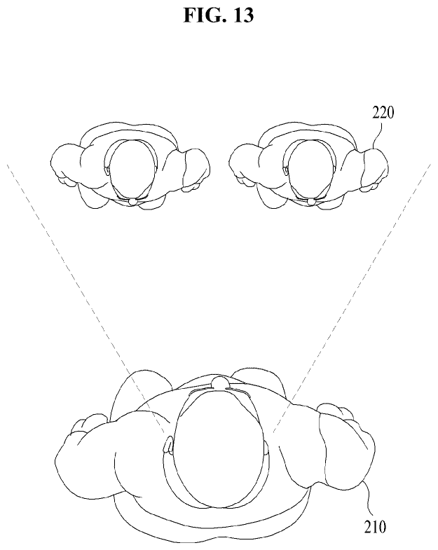

Referring to FIGS. 13 to 15, a method for automatically configuring microphone directionality on the basis of estimating the location of a user 210 or an object 220 by using a hearing aid according to an embodiment will be described. Here, a case in which the number of objects 220 communicating with the user 210 is two people will be described as an example. The number of objects 220 may be two or more people.

FIG. 13 is a diagram for describing location estimation of multiple objects by using a sensor according to an embodiment. As shown in FIG. 13, the location of the two objects 220 may be estimated through the sensor unit of the hearing aid worn by the user 210. At this time, a proximity sensor, a heat-detecting sensor, a movement sensor, or the like may be used as the sensor unit.

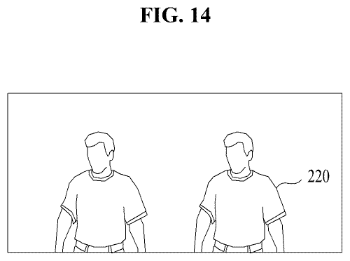

FIG. 14 is a diagram for describing multi-person detection and mapping according to an embodiment. As shown in FIG. 14, the sensor unit of the hearing aid worn by the user 210 detects people, that is, two objects 220 according to the location estimation of the two objects 220, and the location mapping unit may map the locations.

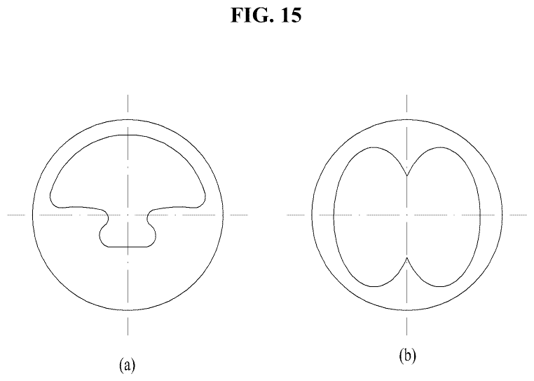

FIG. 15 is a diagram for describing multi-beamforming according to an embodiment. Referring to FIG. 15, the beamforming configuring unit may change to a multi-beamforming setting according to the number of people mapped in the basic beamforming state. When the multi-object 220 is sensed, the beamforming configuring unit may change a beamforming program to achieve desired beamforming.

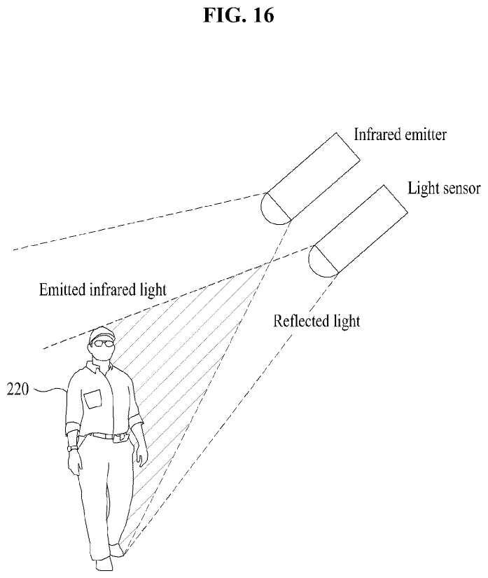

FIG. 16 is a diagram for describing object recognition according to an embodiment.

Referring to FIG. 16, an object 220, that is, a person, may be recognized through infrared light emitted by using an infrared emitter. Further, the light sensor may be used to recognize the object 220 through reflected light. In addition, the infrared emitter and the light sensor may be used to recognize the object 220. At this time, it may be recognized that the object 220 exists in an overlapping portion between a portion recognized by the infrared emitter and a portion recognized by the light sensor.

As described above, according to the embodiments, by estimating the direction or location of the user 210 through the sensor unit of the hearing aid or estimating the direction or location of the object 220 communicating with the user 210, the beamforming for microphone directionality may be automatically changed according to the direction or location of the user 210 or the object 220, thereby making the hearing aid more audible and improving the performance of the hearing aid.

It will be understood that when a component is referred to above as being “connected” or “coupled” to another component, it may be directly connected or coupled to the other component, but intervening components may also be present. In contrast, when a component is referred to as being “directly connected” or “directly coupled” to another component, it should be understood that there are no intervening components present.

The terminology used herein is for the purpose of describing particular embodiments only and is not intended to be limiting of the present disclosure. The singular forms “a,” “an,” and “the” include plural referents unless the context clearly dictates otherwise. It should be understood that terms such as “comprises” and “comprising” are used herein to specify the presence of stated features, numbers, steps, operations, components, parts, or combinations thereof, but do not preclude the presence or addition of one or more other features, numbers, step, operations, components, parts, or combinations thereof.

Although the terms first, second, etc. may be used to describe various components, the components should not be limited by the terms. The terms are only used for the purpose of distinguishing one component from another.

In addition, the terms “unit,” “module,” and the like described in the specification mean a unit that processes at least one function or operation, and may be implemented by hardware, software, or a combination of hardware and software.

In addition, the components of the embodiments described with reference to the drawings are not limited to the embodiments, and may be implemented to be included in other embodiments as long as the technical concept of the present disclosure is maintained, and it is needless to say that a plurality of embodiments may be implemented as a single integrated embodiment again even if a separate description is omitted.

Note that in the description with reference to the accompanying drawings, the same components will be denoted by the same or related reference numerals regardless of the reference numeral, and redundant description thereof will be omitted. In describing the present disclosure, if it is determined that the specific description of the related known technology may unnecessarily obscure the gist of the present disclosure, the detailed description thereof will be omitted.

Although the embodiments have been described above with reference to the limited embodiments and the drawings, those skilled in the art may make various modifications and variations from the above description. For example, suitable results may be achieved if the described techniques are performed in an order different from that described, and/or if components of the described systems, structures, devices, circuits, etc., are combined or brought together in a form different from that described or are replaced or substituted for by other components or equivalents.

Therefore, other implementations, other embodiments, and equivalents of the claims are also within the scope of the following claims.

1. A method for automatically configuring microphone directionality on the basis of estimating the location of a user or an object by using a hearing aid, comprising:
a step of estimating, through a sensor unit of a hearing aid worn by a user, the direction or location of the user or estimating the direction or location of an object communicating with the user; and
a step of automatically changing beamforming for microphone directionality on the basis of the location of the user or the object.

2. The method of claim 1, further comprising:
a step of detecting and mapping the location of the user or the object according to the estimated direction or location, and
automatically changing beamforming for microphone directionality on the basis of the mapped location of the user or the object.

3. The method of claim 1, characterized in that the sensor unit is at least any one or more of an acceleration sensor, a proximity sensor, a lidar sensor, a heat-detecting sensor, a movement sensor, an infrared emitter, and a light sensor.

4. The method of claim 1, characterized in that the step of estimating the direction or location comprises:
configuring a beamforming setting value according to a location and direction of a the user by recognizing a movement direction of the user through a the sensor unit of the hearing aid.

5. The method of claim 1, characterized in that the step of estimating the direction or location comprises:
configuring a beamforming setting value according to the direction or location of the object by estimating, through the sensor unit of the hearing aid, the direction or location of the object when the distance between the user and the object is within a predetermined distance.

6. The method of claim 1, characterized in that the step of estimating the direction or location comprises:
configuring a beamforming setting value according to the direction or location in which a sound is generated by recognizing the direction or location in which the sound is generated.

7. The method of claim 1, characterized in that the step of estimating the direction or location comprises identifying the number of the objects within a predetermined distance from the user, and estimating a direction or location of each of the objects,
and the step of automatically changing beamforming comprises changing to a multi-beamforming setting according to the number of objects.

8. The method of claim 1, characterized in that the step of estimating the direction or location comprises:
recognizing the object through infrared light emitted by using an infrared emitter, and recognizing the object through reflected light by using a light sensor, and then recognizing that the object exists in an overlapping portion between a portion recognized by the infrared emitter and a portion recognized by the light sensor.

9. An apparatus for automatically configuring microphone directionality on the basis of estimating the location of a user or an object by using a hearing aid, comprising:
a sensor unit configured in a hearing aid worn by a user, wherein the sensor unit estimates the direction or location of the user or estimates the direction or location of an object communicating with the user; and
a beamforming configuring unit for automatically changing beamforming for microphone directionality on the basis of a location of the user or the object.

10. The apparatus of claim 9, further comprising:
a location mapping unit for detecting the user or the object on the basis of the estimated direction or location and mapping the location, and
automatically changing beamforming for microphone directionality on the basis of the mapped location of the user or the object.

11. The apparatus of claim 9, characterized in that the sensor unit is at least any one or more of an acceleration sensor, a proximity sensor, a lidar sensor, a heat-detecting sensor, a movement sensor, an infrared emitter, and a light sensor.

12. The apparatus of claim 9, characterized in that the sensor unit recognizes a movement direction of the user, and the beamforming configuring unit configures a beamforming setting value according to a location and a direction of the user.

13. The apparatus of claim 9, characterized in that the sensor unit estimates a direction or location of the object when a distance between the user and the object is within a predetermined distance, so that the beamforming configuring unit configures a beamforming setting value according to the direction or location of the object.

14. The apparatus of claim 9, characterized in that the sensor unit recognizes a direction or location in which sound is generated, and the beamforming configuring unit configures a beamforming setting value according to the direction or location in which the sound is generated.

15. The apparatus of claim 9, characterized in that the sensor unit identifies the number of the objects within a predetermined distance from the user, and estimates a direction or location of each of the objects,
and the beamforming configuring unit changes to a multi-beamforming setting according to the number of objects.

16. The apparatus of claim 9, characterized in that the sensor unit recognizes the object through infrared light emitted by using an infrared emitter, and recognizes the object through reflected light by using a light sensor, and then recognizes that the object exists in an overlapping portion between a portion recognized by the infrared emitter and a portion recognized by the light sensor.
